(19) United States
(12) Patent Application Publication
(10) Pub. No.: US 2002/0021286 A1
(43) Pub. Date: Feb. 21, 2002

(54) Portable wireless terminal with a pointing device

(75) Inventor: Young-Sang Choi, Suwon-city (KR)

Correspondence Address: SUGHRUE MION ZINN MACPEAK & SEAS, PLLC, 2100 Pennsylvania Avenue, NW, Washington, DC, 20037-3213, US

(73) Assignee: SAMSUNG ELECTRONICS CO., LTD.

(21) Appl. No.: 09/912,520

(22) Filed: Jul. 26, 2001

(30) Foreign Application Priority Data
Aug. 18, 2000 (KR) 2000-47708

(51) Int. Cl. G09G 5/00

(52) U.S. Cl. 345/168

(57) ABSTRACT

A portable wireless terminal includes a key pad mounted on a top surface of a main body and a pointing device for moving a cursor on a screen. The pointing device includes a recess formed in one side of the main body, a ball mounted in the recess, and a sensor for sensing rotational displacement of the ball to output a signal to a processor. In the portable wireless terminal, the cursor on the screen moves freely, quickly, and simply in accordance with rotation of the ball. This improves convenience in use of the portable wireless terminal.

### BACKGROUND OF THE INVENTION

1. Field of the Invention

The present invention relates to a portable wireless terminal, and more particularly, to a portable wireless terminal with a pointing device by which an application program is effectively used based on a graphic user interface.

2. Description of the Related Art

Recently, portable wireless terminals, such as cellular phones or personal digital assistant (PDAs), are widely used. Such portable wireless terminals are adapted to use an application program based on a graphic user interface, and is generally provided with a pointing device to effectively use the application program.

As shown in FIG. 1, a related art portable wireless terminal includes two or four buttons 2 of a key pad 1 as pointing devices that serve to perform a scrolling function. Alternatively, the related art portable wireless terminal includes a wheel (not shown) rotatably mounted in one direction on a side or entire surface of a main body.

However, in view of the characteristics of the graphic user interface, in a button manipulation mode, a cursor moves in a vertical or horizontal direction by repeatedly manipulating several buttons with a finger. In this case, a problem arises in that it is inconvenient to input data. The wheel manipulation mode is more convenient than the button manipulation mode. However, a problem still arises in that a cursor moves in a straight direction only, such as a vertical or horizontal direction.

To solve such problems, there is provided a mode in which a mouse for a personal computer is directly connected with a wireless terminal. However, in this case, the user should always carry a separate mouse which is inconvenient.

### SUMMARY OF THE INVENTION

Accordingly, it is a primary object of the present invention to provide a portable wireless terminal in which a pointing device is integrally mounted so that a cursor moves freely, quickly, and simply on a display such as a liquid crystal screen, thereby providing convenience.

In order to achieve the above-described object of the present invention, there is provided a portable wireless terminal including a key pad mounted on a top surface of a main body and a pointing device for moving a cursor on a screen, wherein the pointing device includes a recess formed at one side of the main body, a ball mounted in the recess, and a sensor for sensing rotational displacement of the ball to output a signal to a processor.

Preferably, the recess is formed on a lower surface or the top surface of the main body, and a holder is mounted around the recess to support the ball, so that a part of the ball is exposed from the surface of the main body.

In the aforementioned configuration, in a state where the portable wireless terminal is in contact with a surface, a user moves the portable wireless terminal or directly rotates the ball, so that the cursor on the screen moves freely, quickly, and simply. This improves convenience for use of the portable wireless terminal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a related art wireless terminal;

FIG. 2 is a perspective view of a portable wireless terminal with a pointing device in accordance with the first embodiment of the present invention;

FIG. 3 is a bottom perspective view of the portable wireless terminal of FIG. 2; and

FIG. 4 is a perspective view of a portable wireless terminal with a pointing device in accordance with the second embodiment of the present invention.

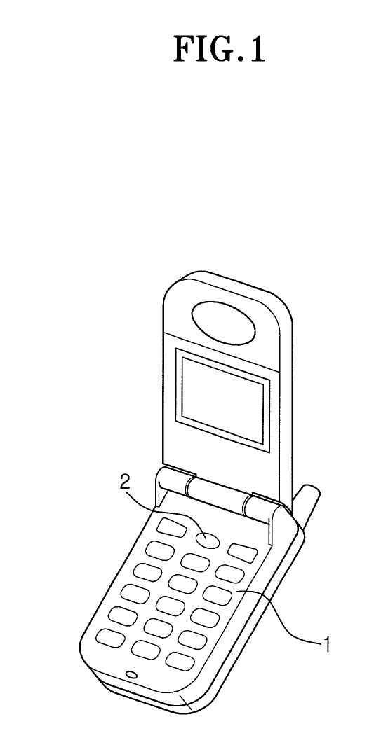

### DETAILED DESCRIPTION OF THE PREFERRED EMBODIMENT

A portable wireless terminal with a pointing device in accordance with preferred embodiments of the present invention will now be described in detail with reference to the accompanying drawings.

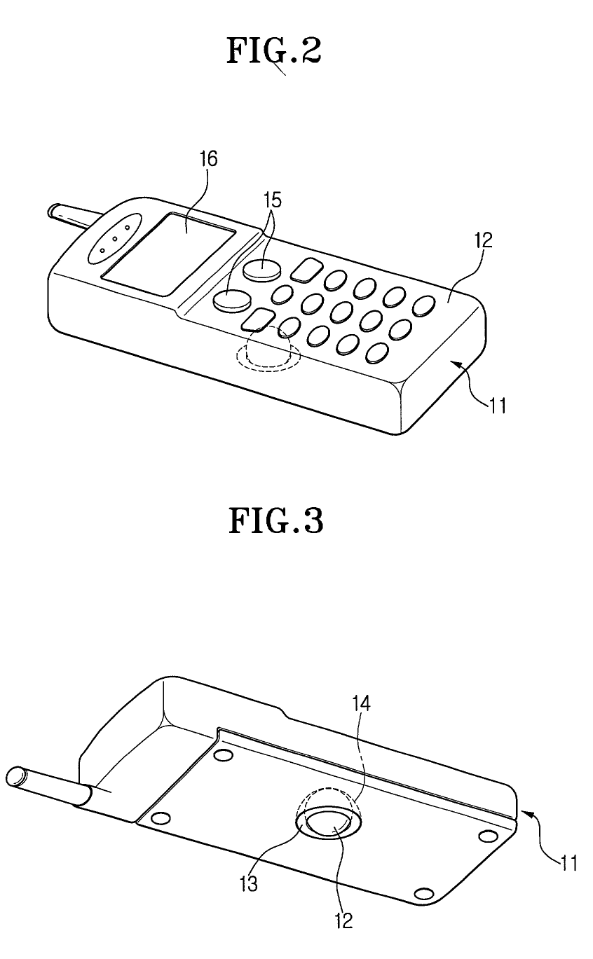

FIG. 2 is a perspective view of a portable wireless terminal with a pointing device in accordance with the first embodiment of the present invention, and FIG. 3 is a bottom perspective view of the portable wireless terminal of FIG. 2.

As shown in FIG. 2, the portable wireless terminal according to the first embodiment of the present invention includes a main body 11, and a key pad 11a formed on a top surface of the main body 11. Two input buttons 15 are formed on the key pad 11a. The input buttons 15 serve as the input buttons of a mouse, as will be described later.

As shown in FIG. 3, a hemispheric recess 14 is formed on a lower surface of the main body 11. A ball 12 and a sensor (not shown) are formed within the recess 14. The ball 12 serves as a pointing device. The sensor senses rotational displacement of the ball 12. A ring shaped holder 13 is formed around the recess 14 to support the ball 12. An internal diameter of the holder 13 is smaller than the diameter of the ball 12 so that a part of the ball 12 is exposed from the surface of the main body 11 without being detached from the recess 14. The sensor outputs a signal corresponding to the rotational displacement of the ball 12 to a processor (not shown) mounted in the main body 11.

In the aforementioned configuration, if a user moves the portable wireless terminal the portable wireless terminal is in contact with a surface, such as a pad surface, a desk surface or a palm surface, the ball 12 is rotated and the sensor outputs a signal corresponding to displacement of the ball 12, i.e., two-dimensional position displacement, to the processor. The processor processes the signal output from the sensor so that a cursor moves on a screen 16 in compliance with rotation of the ball 12. If the cursor reaches a desired position on the liquid crystal screen 16, the user clicks the input buttons 15 formed on the key pad 11a in the same manner as the input buttons of a mouse for a desk top computer, so that a desired menu can be selected or searched.

The signal processing circuit for the ball 12 and sensor, and the method for processing the signal in a processor that moves a cursor in response to a signal output from the sensor are identical to that of a mouse in a well-known desk top computer. Accordingly, their detailed description will be omitted.

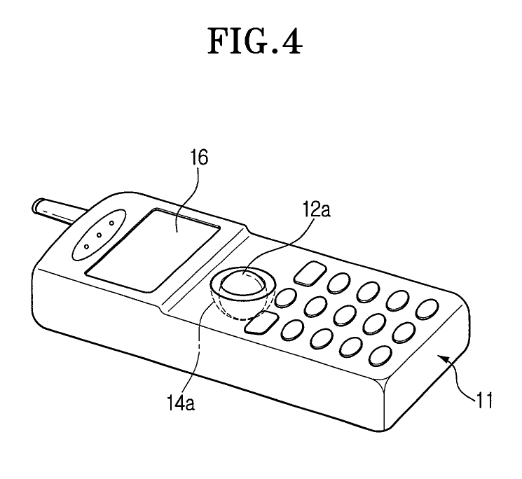

FIG. 4 is a perspective view of a portable wireless terminal with a pointing device in accordance with the second embodiment of the present invention.

Referring to FIG. 4, in the portable wireless terminal according to the second embodiment of the present invention, a recess 14a is formed in a top surface of main body 11 and a pointing device is mounted within the recess 14a. The pointing device is comprised of a ball 12a and a sensor (not shown). In this embodiment, the pointing device is configured in the same manner as that of the first embodiment. However, in the portable wireless terminal according to the second embodiment, a user directly rotates the ball 12a so that the cursor freely moves in all directions. This improves convenience as compared with the first embodiment.

As described above, in the present invention, the pointing device consisting of the ball 12 or 12a and the sensor is mounted on the lower surface or the top surface of the main body 11 of the portable wireless terminal. When the portable wireless terminal is in contact with a surface, the user moves the portable wireless terminal or directly rotates the ball, so that the cursor on the screen 16 moves two-dimensionally, thereby performing scrolling to a desired menu. This enables the cursor to move freely, quickly, and simply, thereby improving convenience for use.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. In a portable wireless terminal including a key pad mounted on a top surface of a main body, and a pointing device for moving a cursor on a display screen, the pointing device comprising:
a recess formed in one side of the main body;
a ball mounted in the recess; and
a sensor for sensing rotational displacement of the ball to output a signal to a processor.

2. The portable wireless terminal of claim 1, wherein the recess is formed in a lower surface of the main body.

3. The portable wireless terminal of claim 1, wherein the recess is formed in the top surface of the main body.

4. The portable wireless terminal of claim 1, further comprising a holder mounted around the recess to support the ball, so that a part of the ball is exposed from the surface of the main body.

5. The portable wireless terminal of claim 1, wherein the key pad is provided with input buttons.

6. A portable wireless device incorporating a mouse function, comprising;
a main body having a top and a bottom surface, and including a display on said top surface;
a mouse-type ball and sensor device incorporated into one of said top and bottom surfaces; and
at least two keys located on said top surface which functionally correspond to right and left-click buttons for a mouse-type ball and sensor device.
